(19) United States
(12) Patent Application Publication
(10) Pub. No.: US 2014/0079927 A1
(43) Pub. Date: Mar. 20, 2014

(54) MATERIAL FOR CONDUCTIVE FILM, CONDUCTIVE FILM LAMINATE, ELECTRONIC DEVICE, AND PROCESSES FOR THEIR PRODUCTION

(71) Applicant: ASAHI GLASS COMPANY, LIMITED, Chiyoda-ku (JP)

(72) Inventors: Kazuhisa YOSHIOKA, Tokyo (JP); Michihisa Tomida, Tokyo (JP); Masayuki Morino, Tokyo (JP)

(73) Assignee: ASAHI GLASS COMPANY, LIMITED, Chiyoda-ku (JP)

(21) Appl. No.: 14/085,001

(22) Filed: Nov. 20, 2013

Related U.S. Application Data
(63) Continuation of application No. PCT/JP2012/062696, filed on May 17, 2012.

(30) Foreign Application Priority Data
May 20, 2011 (JP) 2011-113480

(51) Int. Cl. H01B 5/14

(52) U.S. Cl. CPC H01B 5/14
USPC 428/213; 428/697; 428/448; 428/480; 204/192.15

(57) ABSTRACT

A material for a conductive film 1 contains a transparent base material 2, an underlayer 3, a first amorphous layer 4, and a second amorphous layer 5. The first amorphous layer 4 is laminated on the transparent base material 2 and is made of an indium tin oxide containing from 2 to 15 mass % of tin as calculated as its oxide. Further, the second amorphous layer 5 is laminated on the first amorphous layer 4 and is made of an indium tin oxide containing from 2 to 15 mass % of tin as calculated as its oxide. The content of tin as calculated as its oxide in the second amorphous layer 5 is different from the content of tin as calculated as its oxide in the first amorphous layer 4.

### TECHNICAL FIELD

The present invention relates to a material for a conductive film, a conductive film laminate, an electronic device, and a process for producing the material for a conductive film or the conductive film laminate.

### BACKGROUND ART

Transparent conductive film has been used as a transparent electrode, an electromagnetic shielding film, a planar heating film, an antireflection film, etc. since it has conductivity and optical transparency, and has been attracting attention as a touch panel electrode in recent years. For the touch panel, various types such as a resistive film-type, an electrostatic capacitance coupling-type, and an optical-type are known. The transparent conductive film may be used for the resistive film-type in which a touch position is identified by the contact between the upper and lower electrodes, the electrostatic capacitance coupling-type in which changes in an electrostatic capacitance are detected, etc. The transparent conductive film to be used for the resistive film-type is required to have a high durability since it mechanically contacts with another transparent conductive film, according to its operational principle. Further, the transparent conductive film to be used for the electrostatic capacitance coupling-type or a certain resistive film-type is required to have a good etching property since a number of transparent electrodes are formed by etching to obtain a specific pattern.

Further, the transparent conductive film is required to have a high light transmittance since it is disposed on the front surface of a display unit.

As a transparent conductive film having an improved durability or light transmittance, for example, one in which an amorphous film as a first indium tin oxide layer and a crystallized film as a second indium tin oxide layer are formed, in this order, on one surface of a transparent base material is known. Here, the amount of tin in the first indium tin oxide layer is from 5 to 20 mass % as calculated as its oxide, and the content of tin in the second indium tin oxide layer is from 1 to 4 mass % as calculated as its oxide (refer to e.g. Patent Document 1).

### PRIOR ART DOCUMENT

### Patent Document

Patent Document 1: JP-A-2010-061942

### DISCLOSURE OF INVENTION

### Technical Problem

The transparent conductive film is required to have a high durability, and its durability can be improved by crystallization. However, there is a case where a number of transparent electrodes are formed on the transparent conductive film by etching, and the formation of transparent electrode by etching becomes difficult if it has crystallinity. For example, in a case where the transparent conductive film has crystallinity, the formation of transparent electrode may take a long period of time due to the decrease in etching rate, and the shape of the transparent electrode may not become a desired shape.

From the viewpoint of forming transparent electrode, etc. by etching, it is preferred that an amorphous film, which can be etched easily, is formed firstly, and then an transparent electrode is formed by subjecting the amorphous film to etching, followed by heat treatment for crystallization. In such a case, the amorphous film is required to be crystallized easily by heat treatment. Further, the amorphous film is also required to have a low resistivity when it is crystallized. When the resistivity is low, it is possible to adjust the sheet resistance to a desired range even if the film thickness is small. The transparent conductive film is required to have a high light transmittance, and such a high light transmittance can be obtained by reducing the film thickness.

For example, in the case of an indium tin oxide containing 10 mass % of tin as calculated as its oxide, as compared with one containing 3 mass %, its resistivity decreases significantly when it is crystallized, whereby a desired sheet resistance range can be achieved easily. However, if the film thickness is small, the crystallization of the former one is difficult than that of the latter one. Further, for example, in the case of an indium tin oxide containing 3 mass % of tin as calculated as its oxide, its sheet resistance can be reduced by increasing its film thickness, but its light transmittance decreases as the film thickness increases. Further, even in a case where the film thickness is within a desired range, since the optical property changes as the film thickness changes, readjustment of optical components or devices using it becomes necessary.

The present invention has been made to solve the above-mentioned problems. One of the objects of the present invention is to provide a material for a conductive film which can produce a transparent conductive film having crystallinity and a desired thickness or sheet resistance range, and is to provide a conductive film laminate comprising a transparent conductive film having crystallinity and a desired thickness or sheet resistance range, and an electronic device containing the conductive film laminate.

Further, another object of the present invention is to provide a process for producing the above-described material for a conductive film and the conductive film laminate.

### Solution to Problem

The material for a conductive film of the present invention contains a transparent base material, a first amorphous layer and a second amorphous layer. The first amorphous layer is laminated on the transparent base material and is made of an indium tin oxide containing from 2 to 15 mass % of tin as calculated as its oxide. The second amorphous layer is laminated on the first amorphous layer and is made of an indium tin oxide containing from 2 to 15 mass % of tin as calculated as its oxide, provided that the content of tin as calculated as its oxide in the second amorphous layer is different from the content of tin as calculated as its oxide in the first amorphous layer.

The conductive film laminate of the present invention contains a transparent base material, a first crystalline layer, and a second crystalline layer. The first crystalline layer is laminated on the transparent base material and is made of an indium tin oxide containing from 2 to 15 mass % of tin as calculated as its oxide. The second crystalline layer is laminated on the first crystalline layer and is made of an indium tin oxide containing from 2 to 15 mass % of tin as calculated as its oxide, provided that the content of tin as calculated as its oxide in the second crystalline layer is different from the content of tin as calculated as its oxide in the first crystalline layer.

The electronic device of the present invention is characterized by containing the above-described conductive film laminate of the present invention.

The process for producing the material for a conductive film of the present invention comprises a first film-forming step and a second film-forming step. The first film-forming step is to form a first amorphous layer by sputtering using a first sputtering target made of an indium tin oxide containing from 5 to 15 mass % of tin as calculated as its oxide. The second film-forming step is to form, directly on the surface of the first amorphous layer, a second amorphous layer by sputtering using a second sputtering target made of an indium tin oxide containing from 2 to less than 7 mass % of tin as calculated as its oxide. Here, the content of tin (as calculated as its oxide) in the second sputtering target is different from the content of tin (as calculated as its oxide) in the first sputtering target.

The process for producing the conductive film laminate of the present invention comprises a material production step and a heat treatment step. The material production step is to produce a material for a conductive film by the above-described process for producing the material for a conductive film of the present invention. The heat treatment step is to crystallize the first amorphous layer and the second amorphous layer by subjecting the material for a conductive film to heat treatment.

### Advantageous Effects of Invention

According to the material for a conductive film of the present invention, by laminating a first amorphous layer and a second amorphous layer having certain compositions to make a conductive film precursor, a crystalline transparent conductive film having a desired thickness or sheet resistance range can be obtained when it is subjected to heat treatment. Even in a case where one of the amorphous layers may not be crystallized by itself, when the other amorphous layer is one which can be crystallized, the both layers can be crystallized by combining them to a film thickness of a certain level or higher.

According to the conductive film laminate of the present invention, by laminating a first crystalline film and a second crystalline film having certain compositions to make a transparent conductive film having a desired thickness or sheet resistance range, the durability and the reliability can be improved.

According to the electronic device of the present invention, by using the conductive film laminate of the present invention, the durability, the reliability, etc. can be improved.

According to the process for producing the material for a conductive film of the present invention, by comprising a certain step, the above-described material for a conductive film of the present invention can be produced easily. Further, according to the process for producing the conductive laminate of the present invention, by comprising a certain step, the above-described conductive film laminate of the present invention can be produced easily.

### BRIEF DESCRIPTION OF DRAWINGS

FIG. 1 is a cross-sectional view illustrating one embodiment of the material for a conductive film of the present invention.

FIG. 2 is a cross-sectional view illustrating one embodiment of the conductive film laminate of the present invention.

### DESCRIPTION OF EMBODIMENTS

Now, the present invention will be described in detail.

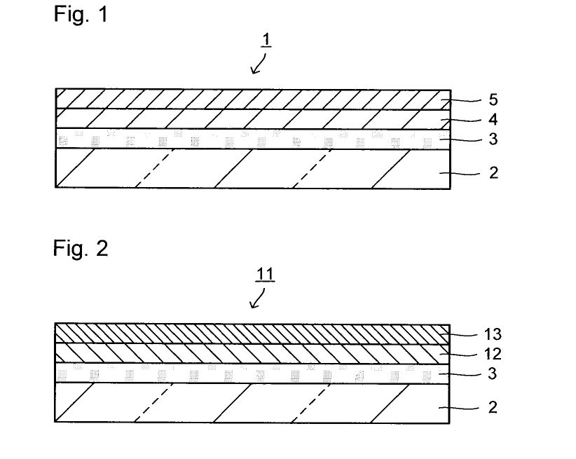

FIG. 1 is a cross-sectional view illustrating one embodiment of the material for a conductive film of the present invention.

A material for a conductive film 1 contains, for example, a transparent base material 2, an underlayer 3, a first amorphous layer 4, and a second amorphous layer 5, in this order. The material for a conductive film 1 of the present invention is used for producing a conductive film laminate containing a crystalline transparent conductive film on the transparent base material 2, and becomes a crystalline transparent conductive film by heat treatment to crystallize the first amorphous layer 4 and the second amorphous layer 5.

Here, in the present invention, “amorphous” and “crystalline” are ones evaluated based on a resistance change ratio (%) obtained by measuring resistance before and after immersing for 5 minutes in a HCl aqueous solution (concentration: 1.5 mol/L) ((resistance after immersion/resistance before immersion)×100). “Amorphous” means that the resistance change ratio exceeds 200%, and “crystalline” means that the resistance change ratio is 200% or lower.

The transparent base material 2 is, for example, preferably a stretched or non-stretched plastic film made of a polyolefin such as polyethylene or polypropylene, a polyester such as polyethylene terephthalate, polybutylene terephthalate or polyethylene naphthalate, a polyamide such as nylon 6 or nylon 66, a polyimide, a polyarylate, a polycarbonate, a polyacrylate, a polyethersulfone, a polysulfone, or copolymers thereof. Further, as the transparent base material 2, other plastic film having a high transparency may also be used. Among them, a plastic film made of polyethylene terephthalate is particularly preferred.

On the one side or both sides of the transparent base material 2, a primer layer such as a hard coat may be formed. Further, on the transparent base material 2, a surface treatment such as an easy-adhesion treatment, a plasma treatment, or a corona treatment may be applied. The thickness of the transparent base material 2 is, from the viewpoint of the flexibility and the durability, preferably from 10 to 200 μm, more preferably from 50 to 180 μm.

The underlayer 3, which is not necessary required, is preferably provided to promote crystallization of the first amorphous layer 4 and the second amorphous layer 5. The underlayer 3 may be one which can promote crystallization of the first amorphous layer 4 and the second amorphous layer 5, and is preferably, for example, one made of an inorganic compound such as a metal or its oxide, sulfide, fluoride or the like, and is usually preferably one made of silicon oxide or aluminum oxide. Silicon oxide is more preferred, and SiOₓ (x is 1.5 to 2) is particularly preferred.

The thickness of the underlayer 3 may be a thickness which can promote crystallization of the first amorphous layer 4 and the second amorphous layer 5, and is preferably at least 1 nm, more preferably at least 3 nm. When the thickness of the underlayer 3 is at least 1 nm, the crystallization of the first amorphous layer 4 and the second amorphous layer 5 can be promoted effectively. When the thickness of the underlayer 3 is around 5 nm, the crystallization of the first amorphous layer 4 and the second amorphous layer 5 can be promoted sufficiently, and when the thickness is at most 5 nm, the productivity and the transparency can be improved.

The first amorphous layer 4 and the second amorphous layer 5 constitute a conductive film precursor which will become a crystalline transparent conductive film when it is crystallized by heat treatment. Each of the first amorphous layer 4 and the second amorphous layer 5 is made of an indium tin oxide which is an oxide of indium and tin, and contains from 2 to 15 mass % of tin as calculated as its oxide (SnO₂, the same applies hereinafter), in the indium tin oxide. As an oxide constitutes the indium tin oxide, an indium oxide, a tin oxide, or a composite oxide comprised of indium oxide and tin oxide may, for example, be mentioned.

Both the first amorphous layer 4 and the second amorphous layer 5 are amorphous. Further, the content of tin as calculated as its oxide in the indium tin oxide of the first amorphous layer 4 is different from that of the second amorphous layer 5.

In the material for a conductive film 1 of the present invention, when the first amorphous layer 4 and the second amorphous layer both which constitute a conductive film precursor are amorphous, the etching property can be improved. Further, when the first amorphous layer 4 and the second amorphous layer 5 both which constitute a conductive film precursor are made of indium tin oxides containing from 2 to 15 mass % of tin as calculated as its oxide, a crystalline transparent conductive film can be obtained by subjecting them to heat treatment for crystallization, and the thickness and the sheet resistance can be adjusted to desired ranges.

Particularly, when the content of tin as calculated as its oxide in the indium tin oxide of the first amorphous layer 4 is different from that of the second amorphous layer 5, it is possible to carry out crystallization easily and adjust the thickness or the sheet resistance of the crystalline transparent conductive film to a desired range, and further, the sheet resistance can be adjusted easily.

Both the first amorphous layer 4 and the second amorphous layer 5 are preferably made only of indium tin oxides, but as the case requires, so long as they do not contradict to the gist of the present invention, may contain components other than indium tin oxides. Such components other than indium tin oxides may, for example, be oxides of aluminum, zirconium, gallium, silicon, tungsten, zinc, titanium, magnesium, cerium, germanium, or the like.

The content of the components other than indium tin oxides in the first amorphous layer 4 is at most 10 mass %, preferably at most 5 mass %, more preferably at most 3 mass %, particularly preferably at most 1 mass %, based on the whole mass of the first amorphous layer 4. Similarly, the content of the components other than indium tin oxides in the second amorphous layer 5 is at most 10 mass %, preferably at most 5 mass %, more preferably at most 3 mass %, particularly preferably at most 1 mass %, based on the whole mass of the second amorphous layer 5.

Between the content of tin as calculated as its oxide in the indium tin oxide of the first amorphous layer 4 and the content of tin as calculated as its oxide in the indium tin oxide of the second amorphous layer 5, either one may be larger than the other. Hereinafter, the content of tin as calculated as its oxide in an indium tin oxide is simply referred to as the content of tin.

When the content of tin in the first amorphous layer 4 is larger than the content of tin in the second amorphous layer 5, the content of tin in the first amorphous layer 4 is preferably from 5 to 15 mass %, and the content of tin in the second amorphous layer 5 is preferably from 2 to less than 7 mass %. When the contents are adjusted to these ranges, the crystallization can be promoted further, and the thickness and the sheet resistance can be adjusted to desired ranges. The content of tin in the first amorphous layer 4 is more preferably from 7 to 13 mass %, and the content of tin in the second amorphous layer 5 is more preferably from 2 to 5 mass %.

On the other hand, when the content of tin in the second amorphous layer 5 is larger than the content of tin in the first amorphous layer 4, the content of tin in the first amorphous layer 4 is preferably from 2 to less than 7 mass %, and the content of tin in the second amorphous layer 5 is preferably from 5 to 15 mass %. When the contents are adjusted to these ranges, the crystallization can be promoted further, and the thickness and the sheet resistance can be adjusted to desired ranges. The content of tin in the first amorphous layer 4 is more preferably from 2 to 5 mass %, and the content of tin in the second amorphous layer 5 is more preferably from 7 to 13 mass %.

Further, between the content of tin in the first amorphous layer 4 and the content of tin in the second amorphous layer 5, either one may be larger than the other, but it is preferred that the former one, i.e. the content of tin in the first amorphous layer 4 is larger than the content of tin in the second amorphous layer 5, since the first amorphous layer 4 and the second amorphous layer 5 can be crystallized to have a wide thickness range with larger freedom, and the sheet resistance of the crystalline transparent conductive film can be adjusted easily in such a case.

When the thickness of an amorphous layer having a higher tin content, between the first amorphous layer 4 and the second amorphous layer 5, is designated as a [nm] and the thickness of an amorphous layer having a lower tin content is designated as b [nm], the sum of these thicknesses a+b is preferably 15≦a+b≦50, more preferably 18≦a+b≦30. When the thickness a+b is within the above range, the first amorphous layer 4 and the second amorphous layer 5 can be crystallized easily, and the relationship between the thickness and the sheet resistance of the crystalline transparent conductive film can be improved. Further, the thickness of the first amorphous layer 4 “a” is preferably at least 6 nm, more preferably at least 8 nm.

Further, the thicknesses “a” and “b” preferably satisfy b≧12−a/2. When they satisfy this relationship, the first amorphous layer 4 and the second amorphous layer 5 can be crystallized more easily, and the relationship between the thickness and the sheet resistance of the crystalline transparent conductive film can be improved.

The material for a conductive film 1 may become a conductive film laminate comprising a crystalline transparent conductive film when the first amorphous layer 4 and the second amorphous layer 5 are crystallized by heat treatment. The heat treatment is, for example, carried out in air at a temperature of from 100 to 170° C., preferably from 125 to 150° C., for a period of from 5 to 180 minutes, preferably from 10 to 60 minutes. When the heat treatment temperature is at least 100° C. and the heat treatment time is at least 30 minutes, the first amorphous layer 4 and the second amorphous layer 5 can be crystallized effectively. Further, when the heat treatment temperature is 170° C. and the heat treatment time is 180 minutes, they can be crystallized sufficiently, and when the heat treatment temperature or the heat treatment time is decreased further, the damage of the transparent base material 2, etc. other than the first amorphous layer 4 and the second amorphous layer 5 can be suppressed, and the productivity can also be improved.

FIG. 2 is a cross-sectional view illustrating one embodiment of a conductive film laminate 11 obtained by subjecting the material for a conductive film 1 to heat treatment. The conductive film laminate 11 contains, for example, the transparent base material 2, the underlayer 3, a first crystalline layer 12, and a second crystalline layer 13, in this order. The first crystalline layer 12 is obtained by crystallizing the first amorphous layer 4, and the second crystalline layer 13 is obtained by crystallizing the second amorphous layer 5.

The crystalline transparent conductive film is comprised of the first crystalline layer 12 and the second crystalline layer 13. Further, although it is not shown in the figure, the crystalline transparent conductive film is not necessarily limited to one comprised only of these two layers, i.e. the first crystalline layer 12 and the second crystalline layer 13. For example, in between the first crystalline layer 12 and the second crystalline layer 13, a crystalline layer having a composition intermediate between the compositions of the first crystalline layer 12 and the second crystalline layer 13 may be contained. Further, on the first crystalline layer 12 and the second crystalline layer 13 constituting the crystalline transparent conductive film, a number of transparent electrodes, etc. may be formed by etching.

Both the first crystalline layer 12 and the second crystalline layer 13 are made of indium tin oxides which are oxides of indium and tin, and in the indium tin oxides, tin is contained from 2 to 15 mass % as calculated as its oxide. Further, both the first crystalline layer 12 and the second crystalline layer 13 have crystallinity. Further, between the first crystalline layer 12 and the second crystalline layer 13, the contents of tin in the indium tin oxides as calculated as its oxide are different from each other. Further, it is preferred that the indium tin oxides have a crystalline structure of indium oxide (In₂O₃) and the indium site is substituted by tin.

In the conductive film laminate 11, by letting the first crystalline layer 12 and the second crystalline layer 13 to have crystallinity, the durability can be improved. Further, when both the first crystalline layer 12 and the second crystalline layer 13 are made of indium tin oxides containing from 2 to 15 mass % of tin as calculated as its oxide and their tin contents are different from each other, the thickness and the sheet resistance can be adjusted to desired ranges.

The relationship between the content of tin and the thickness in each of the first crystalline layer 12 and the second crystalline layer 13 may be adjusted similarly to, for example, the relationship between the content of tin and the thickness in each of the first amorphous layer 4 and the second amorphous layer 5. The resistivity of the crystalline transparent conductive film containing the first crystalline layer 12 and the second crystalline layer 13 is preferably at most 4.0×10⁻⁴ Ω·cm, more preferably at most 3.5×10⁻⁴ Ω·cm, particularly preferably at most 3.0×10⁻⁴ Ω·cm. Further, the sheet resistance of the crystalline transparent conductive film is preferably from 50 to 500 Ω/□, more preferably from 70 to 200 Ω/□.

The conductive film laminate 11 is suitably used for electronic devices, and particularly suitably used for electronic devices containing a display unit and a touch panel disposed on the front surface of the display unit. Particularly, the conductive film laminate 11 is used in a touch panel as a substrate containing transparent electrodes. The conductive film laminate 11 may be used for a resistance film-type touch panel in which a touch position is identified by the contact between the upper and lower electrodes, or an electrostatic capacitance coupling-type touch panel in which changes in an electrostatic capacitance are sensed.

Next, the process for producing the material for a conductive film 1 will be described.

The material for a conductive film 1 can be produced by forming, on the transparent base material 2, after forming the underlayer 3 as the case requires, the first amorphous layer 4, and the second amorphous layer 5, in this order. The film-forming process is not particularly limited, and a sputtering method, an ion plating method, or a vacuum deposition method may be used, and is particularly preferably a sputtering method.

The first amorphous layer 4 may, for example, be formed by a sputtering method using a first sputtering target made of an indium tin oxide. The first sputtering target preferably contains, in the indium tin oxide, from 2 to 15 mass % of tin as calculated as its oxide. The indium tin oxide in the first sputtering target is preferably made of a sintered body that has been sintered after mixing tin oxide (SnO₂) and indium oxide (In₂O₃).

The second amorphous layer 5 may, for example, be formed by a sputtering method using a second sputtering target made of an indium tin oxide. The second sputtering target preferably contains, in the indium tin oxide, from 2 to 15 mass % of tin as calculated as its oxide. Further, the indium tin oxide in the second sputtering target is preferably made of a sintered body that has been sintered after mixing tin oxide (SnO₂) and indium oxide (In₂O₃). Further, the content of tin (as calculated as its oxide) in the second sputtering target is different from the content of tin (as calculated as its oxide) in the first sputtering target.

Between the content of tin in the indium tin oxide of the first sputtering target as calculated as its oxide and the content of tin in the indium tin oxide of the second sputtering target as calculated as its oxide, either one may be larger than the other. The content of tin in each of the first sputtering target and the second sputtering target may appropriately be selected according to the first amorphous layer 4 and the second amorphous layer 5 which are desired to be obtained.

When the content of tin in the first sputtering target is larger than the second sputtering target, the content of tin in the first sputtering target is preferably from 5 to 15 mass %, and the content of tin in the second sputtering target is preferably from 2 to less than 7 mass %. The content of tin in the first sputtering target as calculated as its oxide is more preferably from 7 to 13 mass %, and the content of tin in the second sputtering target as calculated as its oxide is more preferably from 2 to 5 mass %.

On the other hand, when the content of tin in the second sputtering target as calculated as its oxide is larger than the first sputtering target, the content of tin in the first sputtering target as calculated as its oxide is preferably from 2 to less than 7 mass %, and the content of tin in the second sputtering target as calculated as its oxide is preferably from 5 to 15 mass %. The content of tin in the first sputtering target as calculated as its oxide is more preferably from 2 to 5 mass %, and the content of tin in the second sputtering target as calculated as its oxide is more preferably from 7 to 13 mass %.

The first amorphous layer 4 and the second amorphous layer 5 are preferably formed by sputtering while introducing a mixed gas prepared by mixing, for example, from 0.5 to 10 vol %, preferably from 0.8 to 6 vol %, of oxygen gas to argon gas. When the sputtering is carried out while introducing such a mixed gas, it is possible to form one which is easily crystallized by heat treatment and having a desired sheet resistance range after crystallization.

The conductive film laminate 11 can be produced by subjecting the material for a conductive film 1 to heat treatment and crystallizing the first amorphous layer 4 and the second amorphous layer 5, as described above. The heat treatment is preferably, for example, carried out in air with the above-described temperature and time ranges.

### EXAMPLES

Now, the present invention will be described with reference to Examples. However, it should be understood that the present invention is by no means restricted to such specific Examples.

Examples 1 to 5 are working examples and Examples 6 and 7 are comparative examples. Further, the thickness used in each of Examples 1 to 7 is a value obtained from optical properties or a value obtained from a sputtering film-forming rate and a sputtering time, and is not a thickness actually measured.

### Example 1

On a PET (polyethylene terephthalate) film having a thickness of 100 μm as a transparent base material, a SiO₂ film having a thickness of 32 angstrom was formed as an underlayer. The SiO₂ film was formed by using a boron-doped polysilicon target to carry out AC magnetron sputtering with a pressure of 0.2 Pa while introducing a mixed gas prepared by mixing 28 vol % of oxygen gas to argon gas. Further, the thickness of the SiO₂ film was adjusted by adjusting the power density and the sputtering time.

On the SiO₂ film formed on the PET film, a first amorphous layer having a thickness of 151 angstrom was formed by using target A made of an indium tin oxide (hereinafter referred as ITO target A) and carrying out DC magnetron sputtering with a pressure of 0.25 Pa, while introducing a mixed gas prepared by mixing 1.4 vol % of oxygen gas to argon gas (first film-forming step).

Here, the ITO target A is made of a sintered body sintered after mixing 10 mass % of tin oxide (SnO₂) and 90 mass % of indium oxide (In₂O₃). Further, the thickness of the first amorphous layer was adjusted by adjusting the power density and the sputtering time. Further, the content of tin (as calculated as its oxide) in the first amorphous layer is estimated to be about 10 mass %.

Further, on the first amorphous layer, a second amorphous layer having a thickness of 47 angstrom was formed by using target B made of an indium tin oxide (hereinafter referred to as ITO target B) and carrying out DC magnetron sputtering with pressure of 0.25 Pa, while introducing a mixed gas prepared by mixing 1.4 vol % of oxygen gas to argon gas (second film-forming step), thereby to produce a material for a conductive film (material production step).

Here, the ITO target B was made of a sintered body sintered after mixing 3 mass % of tin oxide (SnO₂) and 97 mass % of indium oxide (In₂O₃). Further, the thickness of the second amorphous layer was adjusted by adjusting the power density and the sputtering time.

The obtained material for a conductive film was subjected to heat treatment in air at a temperature of 150° C. for 100 minutes to produce a conductive film laminate (heat treatment step).

### Example 2

A material for a conductive film was produced in the same manner as in Example 1 except that the thickness of the SiO₂ film, the thickness of the first amorphous layer, and the thickness of the second amorphous layer were changed to 53 angstrom, 96 angstrom, and 99 angstrom, respectively. Then, the obtained material for a conductive film was subjected to heat treatment to produce a conductive film laminate.

### Example 3

A material for a conductive film was produced in the same manner as in Example 1 except that the thickness of the SiO₂ film, the thickness of the first amorphous layer, and the thickness of the second amorphous layer were changed to 71 angstrom, 131 angstrom, and 134 angstrom, respectively. Then, the obtained material for a conductive film was subjected to heat treatment to produce a conductive film laminate.

### Example 4

A PET film on which a SiO₂ film was formed was produced in the same manner as in Example 1 except that the thickness of the SiO₂ film was changed to 70 angstrom. On the SiO₂ film formed on the PET film, a first amorphous layer having a thickness of 134 angstrom was formed by using ITO target B and carrying out DC magnetron sputtering with a pressure of 0.25 Pa, while introducing a mixed gas prepared by mixing 1.4 vol % of oxygen gas to argon gas (first film-forming step). Here, the thickness of the first amorphous layer was adjusted by adjusting the power density and the sputtering time.

Further, on the first amorphous layer, a second amorphous layer having a thickness of 131 angstrom was formed by using target A and carrying out DC magnetron sputtering with pressure of 0.25 Pa, while introducing a mixed gas prepared by mixing 1.4 vol % of oxygen gas to argon gas (second film-forming step), thereby to produce a material for a conductive film (material production step). Here, the thickness of the second amorphous layer was adjusted by adjusting the power density and the sputtering time.

The obtained material for a conductive film was subjected to heat treatment in air at a temperature of 150° C. for 100 minutes to produce a conductive film laminate (heat treatment step).

### Example 5

A PET film on which a SiO₂ film was formed was produced in the same manner as in Example 1 except that the thickness of the SiO₂ film was changed to 31 angstrom. On the SiO₂ film formed on the PET film, a first amorphous layer having a thickness of 86 angstrom was formed by using ITO target A and carrying out DC magnetron sputtering with a pressure of 0.25 Pa, while introducing a mixed gas prepared by mixing 1.4 vol % of oxygen gas to argon gas (first film-forming step). Here, the thickness of the first amorphous layer was adjusted by adjusting the power density and the sputtering time.

Further, on the first amorphous layer, a second amorphous layer having a thickness of 96 angstrom was formed by using target C and carrying out DC magnetron sputtering with pressure of 0.25 Pa, while introducing a mixed gas prepared by mixing 1.7 vol % of oxygen gas to argon gas (second film-forming step), thereby to produce a material for a conductive film (material production step). Here, the ITO target C is made of a sintered body sintered after mixing 5 mass % of tin oxide (SnO₂) and 95 mass % of indium oxide (In₂O₃). The thickness of the second amorphous layer was adjusted by adjusting the power density and the sputtering time.

The obtained material for a conductive film was subjected to heat treatment in the same manner as in Example 1 to produce a conductive film laminate.

### Example 6

A PET film on which a SiO₂ film was formed was produced in the same manner as in Example 1 except that the thickness of the SiO₂ film was changed to 52 angstrom. On the SiO₂ film formed on the PET film, an amorphous layer having a thickness of 195 angstrom was formed to obtain a comparative material by using ITO target A and carrying out DC magnetron sputtering with a pressure of 0.25 Pa, while introducing a mixed gas prepared by mixing 1.4 vol % of oxygen gas to argon gas. The thickness of the amorphous layer was adjusted by adjusting the power density and the sputtering time. Thereafter, heat treatment was carried out in air at a temperature of 150° C. for 100 minutes to produce a comparative laminate.

### Example 7

A comparative material and a comparative laminate were produced in the same manner as in Example 6 except that the thickness of the SiO₂ film was changed to 51 angstrom, ITO target B was used, and the thickness of the amorphous layer was changed to 186 angstrom.

Then, the materials and the laminates obtained in Examples 1 to 7 were evaluated based on the following criteria. The results are shown in Table 1.

Further, in the Table, “10ITO” is one containing 10 mass % of tin as calculated as its oxide, “3ITO” is one containing 3 mass % of tin as calculated as its oxide, and “5ITO” is one containing 5 mass % of tin as calculated as its oxide.

### Crystallinity

The resistance was measured before and after immersing the laminate for 5 minutes in a HCl aqueous solution (concentration: 1.5 mol/L), and then a resistance change ratio (%) ((resistance after immersion/resistance before immersion)×100) was obtained. Further, as described above, the resistance change ratio is an index of crystallinity, and one having a resistance change ratio of at most 200% has crystallinity.

### Resistivity

Each of the materials and the laminates was cut to a size of 100 mm×100 mm, and then the sheet resistance of the transparent conductive film was measured by a four-probe method using Lorester (manufactured by Mitsubishi Chemical Corporation, product name). By using the sheet resistance, the resistivity of the transparent conductive film was obtained according to the following formula (1). Here, the thickness of the transparent conductive film in the formula (1) is the sum of the thicknesses of the first amorphous layer and the second amorphous layer for the materials and the laminates of Examples 1 to 5, and is the thickness of the amorphous layer for the materials and the laminates of Examples 6 and 7.

Resistivity [Ω·cm]=sheet resistance [Ω/□]×thickness [Å]÷10⁸ (1)

TABLE 1

| | | Amorphous layer • Amorphous film | | | | | Crystallinity | | |
|---|---|---|---|---|---|---|---|---|---|
| | Underlayer | Composition | | Thickness [Å] | | | Resistance | Resistivity [Ω · cm] | |
| | Thickness | First | Second | First | Second | | change ratio | Before heat | After heat |
| | [Å] | layer | layer | layer | layer | Sum | [%] | treatment | treatment |
| Ex. 1 | 32 | 10ITO | 3ITO | 151 | 47 | 198 | 100 | 6.1 × 10⁻⁴ | 2.4 × 10⁻⁴ |
| Ex. 2 | 53 | 10ITO | 3ITO | 96 | 99 | 195 | 100 | 7.5 × 10⁻⁴ | 3.0 × 10⁻⁴ |
| Ex. 3 | 71 | 10ITO | 3ITO | 131 | 134 | 265 | 100 | 7.2 × 10⁻⁴ | 2.9 × 10⁻⁴ |
| Ex. 4 | 70 | 3ITO | 10ITO | 134 | 131 | 265 | 107 | 6.6 × 10⁻⁴ | 3.2 × 10⁻⁴ |
| Ex. 5 | 31 | 10ITO | 5ITO | 86 | 96 | 182 | 102 | 6.6 × 10⁻⁴ | 2.6 × 10⁻⁴ |
| Ex. 6 | 52 | 10ITO | — | 195 | — | 195 | ∞ | 7.8 × 10⁻⁴ | 6.1 × 10⁻⁴ |
| Ex. 7 | 51 | 3ITO | — | 186 | — | 186 | 110 | 7.0 × 10⁻⁴ | 5.4 × 10⁻⁴ |

According to the materials of Examples 1 to 5, when they are subjected to heat treatment, laminates containing a transparent conductive film having crystallinity and a low resistivity can be obtained. On the other hand, according to the material of Example 6, a laminate containing a transparent conductive film having crystallinity cannot be obtained. Further, according to the material of Example 7, while one having crystallinity can be obtained, a laminate containing a transparent conductive film having a low resistivity cannot be obtained. Further, in Examples 1 to 4, the transparent conductive film was crystallized since 3ITO which can be crystallized easily is used in combination, the resistivity of the transparent conductive film can be decreased after heat treatment.

### INDUSTRIAL APPLICABILITY

The conductive film laminate is comprised of a transparent conductive film which is obtained by subjecting the material for a conductive film of the present invention to heat treatment and has crystallinity and a desired thickness or sheet resistance value can be used for an electronic device such as a touch panel.

This application is a continuation of PCT Application No. PCT/JP2012/062696, filed on May 17, 2012, which is based upon and claims the benefit of priority from Japanese Patent Application No. 2011-113480 filed on May 20, 2011. The contents of those applications are incorporated herein by reference in its entirety.

### REFERENCE SYMBOLS

1 . . . material for a conductive film, 2 . . . transparent base material, 3 . . . underlayer, 4 . . . first amorphous layer, 5 . . . second amorphous layer, 11 . . . conductive film laminate, 12 . . . first crystalline layer, and 13 . . . second crystalline layer

What is claimed is:

1. A material for a conductive film comprising a transparent base material, a first amorphous layer laminated on the transparent base material and made of an indium tin oxide containing from 2 to 15 mass % of tin as calculated as its oxide, and a second amorphous layer laminated on the first amorphous layer and made of an indium tin oxide containing from 2 to 15 mass % of tin as calculated as its oxide, provided that the content of tin as calculated as its oxide in the second amorphous layer is different from the content of tin as calculated as its oxide in the first amorphous layer.

2. The material for a conductive film according to claim 1, wherein the content of tin as calculated as its oxide in an amorphous layer having a higher tin content between the first amorphous layer and the second amorphous layer is from 5 to 15 mass % as calculated as its oxide, and the content of tin as calculated as its oxide in an amorphous layer having a lower tin content is from 2 to less than 7 mass % as calculated oxides.

3. The material for a conductive film according to claim 1, wherein a+b satisfies 15≦a+b≦50, where a is the thickness of an amorphous layer having a higher tin content between the first amorphous layer and the second amorphous layer, b is the thickness of an amorphous layer having a lower tin content, and a+b is the sum of them.

4. The material for a conductive film according to claim 1, which satisfies b≧12−a/2, where a is the thickness of an amorphous layer having a higher tin content between the first amorphous layer and the second amorphous layer, and b is the thickness of an amorphous layer having a lower tin content.

5. The material for a conductive film according to claim 1, wherein the content of tin as calculated as its oxide in the first amorphous layer is higher than the content of tin as calculated as its oxide in the second amorphous layer.

6. The material for a conductive film according to claim 1, which contains a silicon oxide layer between the transparent base material and the first amorphous layer.

7. The material for a conductive film according to claim 1, wherein the first amorphous layer and the second amorphous layer are crystallized by heat treatment.

8. The material for a conductive film according to claim 1, wherein the transparent base material is polyethylene terephthalate.

9. A conductive film laminate comprising a transparent base material, a first crystalline layer laminated on the transparent base material and made of an indium tin oxide containing from 2 to 15 mass % of tin as calculated as its oxide, and a second crystalline layer laminated on the first amorphous layer and made of an indium tin oxide containing from 2 to 15 mass % of tin as calculated as its oxide, provided that the content of tin as calculated as its oxide in the second crystalline layer is different from the content of tin as calculated as its oxide in the first crystalline layer.

10. An electronic device comprising the conductive film laminate as defined in claim 9.

11. A process for producing a material for a conductive film, which comprises a first film-forming step for forming a first amorphous layer by sputtering using a first sputtering target made of an indium tin oxide containing from 5 to 15 mass % of tin as calculated as its oxide, and a second film-forming step for forming a second amorphous layer by sputtering using a second sputtering target made of an indium tin oxide containing from 2 to less than 7 mass % of tin as calculated as its oxide, provided that the content of tin (as calculated as its oxide) in the second sputtering target is different from the content of tin (as calculated as its oxide) in the first sputtering target.

12. A process for producing a conductive film laminate, which comprises a material production step for producing a material for a conductive film by the production process as defined in claim 11, and a heat treatment step for crystallizing the first amorphous layer and the second amorphous layer by subjecting the material for a conductive film to heat treatment.

13. The process for producing a conductive film laminate according to claim 12, wherein the heat treatment step is carried out at a temperature of from 100 to 170° C. for from 30 to 180 minutes.
